(19) United States
(12) Patent Application Publication
(10) Pub. No.: US 2026/0294714 A1
(43) Pub. Date: Oct. 1, 2026

(54) SYSTEM AND METHOD FOR PREVENTION OF ULCERS

(71) Applicant: Vanderbilt University, Nashville, TN (US)

(72) Inventors: Linxuan Li, Nashville, TN (US); Kaelyn Fann, Nashville, TN (US); Caroline Sims, Nashville, TN (US); John Paul Libanati, Nashville, TN (US); Stanley Vinet, Nashville, TN (US); Danielle Hayes, Nashville, TN (US); Helen A. Schafer, Nashville, TN (US)

(21) Appl. No.: 19/634,592

(22) Filed: Mar. 31, 2026

Related U.S. Application Data
(60) Provisional application No. 63/780,650, filed on Mar. 31, 2025.

(51) Int. Cl. A61G 7/057

(52) U.S. Cl. CPC A61G 7/05776

(57) ABSTRACT

A pad assembly for preventing pressure-induced injuries, the pad assembly including: a plurality of pads, each of the plurality of pads configured to couple to one or more adjacent pads and including a chamber; a tube connector in fluid communication with the chamber of each of the plurality of pads; a plurality of tubes, each of the plurality of tubes configured to couple to the tube connector of at least one of the plurality of pads; wherein the chamber of each of the plurality of pads is configured to receive air through the tube connector corresponding thereto and one of the plurality of tubes, such that the chamber of each of the plurality of pads is selectively inflatable.

### CROSS-REFERENCE TO RELATED APPLICATIONS

The present application claims priority to U.S. Provisional Patent Application No. 63/780,650, filed Mar. 31, 2025, the entire contents of which are incorporated herein by reference.

### BACKGROUND

Patients who are immobile for extended periods of time may form decubitus ulcers due to prolonged pressure on certain areas of the body, causing impaired blood flow and moisture buildup. Hospitals often bear the cost of treating these ulcers, as insurance providers classify them as “never events.”

Accordingly, a cost-effective and disposable device is desirable to prevent ulcers from forming in immobile patients.

### SUMMARY

The present disclosure provides a system and method that addresses the issue of pressure-induced injuries by dynamically redistributing force on areas prone to excessive pressure. This is achieved through an adjustable support system utilizing variable inflation mechanisms. By modifying pressure distribution over time, the system enhances blood circulation and nutrient delivery to vulnerable regions, thereby reducing the likelihood of injury. Additionally, a moisture-regulating disposable outer layer helps maintain an optimal skin environment for both prevention and healing.

The system is designed for durability and reusability, providing a cost-effective alternative to conventional solutions. It is compatible with various external control systems that regulate inflation, allowing integration with multiple pressure-modulating devices used in clinical environments. Independent inflation control mechanisms enable adaptability across different patient sizes and anatomical locations, reducing the need for specialized models.

Additionally, the system is designed for ease of application and reduced caregiver workload. A modular structure allows for quick adjustments, while a multi-layer covering system facilitates hygiene management and maintenance. The outermost layer is configured for periodic replacement to align with standard care intervals, minimizing the frequency of patient repositioning.

In one implementation, the present disclosure provides a cost-effective, disposable, alternating pressure cushion to prevent formation of ulcers by redistributing pressure on the sacrum and ischial tuberosities, while also wicking moisture. The cushion reduces the manual burden on healthcare workers by automating repositioning and is designed to align with an 8-hour nursing shift for ease of use.

In some aspects, the techniques described herein relate to a pad assembly for preventing pressure-induced injuries, the pad assembly including: a plurality of pads, each of the plurality of pads including a chamber and a fastener; a tube connector in fluid communication with the chamber of each of the plurality of pads; a plurality of tubes, each of the plurality of tubes configured to couple to the tube connector of at least one of the plurality of pads; wherein the fastener of each of the plurality of pads is configured to removably couple to the fastener of at least one adjacent pad of the plurality of pads, wherein the plurality of pads is couplable to one or more adjacent pads of the plurality of pads in a first configuration and the plurality of pads is couplable to one or more of adjacent pads of the plurality of pads in a second configuration different from the first configuration; and wherein the chamber of each of the plurality of pads is configured to receive air through the tube connector corresponding thereto and one of the plurality of tubes, such that the chamber of each of the plurality of pads is selectively inflatable.

In some aspects, the techniques described herein relate to a pad assembly for preventing pressure-induced injuries, the pad assembly including: a plurality of pads, each of the plurality of pads configured to couple to one or more adjacent pads and including a chamber; a tube connector in fluid communication with the chamber of each of the plurality of pads; a plurality of tubes, each of the plurality of tubes configured to couple to the tube connector of at least one of the plurality of pads; wherein the chamber of each of the plurality of pads is configured to receive air through the tube connector corresponding thereto and one of the plurality of tubes, such that the chamber of each of the plurality of pads is selectively inflatable.

In some aspects, the techniques described herein relate to a system for preventing pressure-induced injuries, the system including: a pump; and a pad assembly including a plurality of pads, each of the plurality of pads configured to coupled to one or more adjacent pads and including a chamber; a tube connector in fluid communication with the chamber of each of the plurality of pads; a plurality of tubes, each of the plurality of tubes configured to couple between the pump and the tube connector of at least one of the plurality of pads; wherein the chamber of each of the plurality of pads is configured to receive air from the pump through the tube connector corresponding thereto and one of the plurality of tubes, such that the chamber of each of the plurality of pads is selectively inflatable.

Other aspects of the disclosure will become apparent by consideration of the detailed description and accompanying drawings.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 illustrates a system for prevention of pressure-induced injuries according to an embodiment of the present disclosure, the system including a pad assembly and a pump.

FIG. 2 illustrates a system for prevention of pressure-induced injuries according to another embodiment of the present disclosure, the system including a pad assembly and a pump.

FIG. 3A illustrates a system for prevention of pressure-induced injuries according to another embodiment of the present disclosure, the system including a pad assembly and a pump.

FIG. 3B illustrates a pad assembly for preventing pressure-induced injuries according to another embodiment and usable with the systems of FIGS. 1-3.

FIG. 4 illustrates a perspective view of a pad for use with the pad assemblies of FIGS. 1-3B.

FIG. 5A illustrates a perspective view of a tube adapter for use with the pad of FIG. 4.

FIG. 5B illustrates a cross-sectional view of the tube adapter of FIG. 5A.

FIG. 6A illustrates a tube connector according to an embodiment for use with the tube adapter of FIGS. 5A and 5B.

FIG. 6B illustrates a tube connector according to another embodiment for use with the tube adapter of FIGS. 5A and 5B.

FIG. 6C illustrates a tube connector according to another embodiment for use with the tube adapter of FIGS. 5A and 5B.

FIG. 7 illustrates a plug for use with the tube adapter of FIGS. 5A and 5B.

FIG. 8 illustrates a cross-sectional view of the pad of FIG. 4 together with the tube adapter of FIGS. 5A and 5B, the tube connector of FIG. 6A, and the plug of FIG. 7.

FIG. 9A illustrates an integrally formed tube adapter and tube connector according to an embodiment for use with the pad of FIG. 4.

FIG. 9B illustrates an integrally formed tube adapter and tube connector according to another embodiment for use with the pad assemblies of FIGS. 1-3B.

FIG. 9C illustrates an integrally formed tube adapter and tube connector according to another embodiment for use with the pad assemblies of FIGS. 1-3B.

FIG. 10 illustrates a cap for use with the tube connectors of FIGS. 6A-6C and FIGS. 9A-9C.

FIG. 11 illustrates a cover for the pad assemblies of FIGS. 1-3B.

FIG. 12 illustrates the cover of FIG. 11 in use with one of the pad assemblies of FIGS. 1-3B.

FIG. 13 illustrates a plurality of pressure maps for the pad assembly of FIG. 3A.

FIG. 14A illustrates a graph of absorbance versus material type for the cover of FIG. 11.

FIG. 14B illustrates a graph of vertical height versus time for different materials in a wicking test for the cover of FIG. 11.

FIG. 15A illustrates a graph of pressure mapping for the pad assembly of FIG. 3A.

FIG. 15B illustrates a graph of pressure mapping for the pad assembly of FIG. 3A.

FIG. 16 illustrates a cost optimization for the pad assembly of FIG. 3A.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

The system comprises a cushion including a plurality of inflatable sections that can be arranged in a plurality of configurations to optimize support and offloading capabilities. The sections utilize attachment mechanisms to ensure proper configuration based on patient needs. The system and method include an inflation process that follows a sequential pattern to enhance pressure redistribution by periodically shifting the contact points between the patient and the support surface.

One feature of the system is its high degree of customizability, allowing for flexible configurations to accommodate various body types, anatomical locations, and clinical applications. The modular nature of the support structure enables healthcare providers to adjust, reposition, or remove individual support elements based on patient-specific requirements. By integrating attachment mechanisms to each chamber, the system can be rearranged in different layouts to target pressure relief across diverse regions of the body.

The cushion includes an exterior cover having a plurality of layers configured to balance comfort, durability, and moisture management. Select materials with wicking, absorbent, or cushioning properties may be incorporated to improve patient experience and maintain a dry interface between the cushion and the skin.

The overall configuration enables customizable applications, including but not limited to, support for different body areas, various patient sizes, and compatibility with existing pressure-relief devices. The modular and adaptable nature of the system ensures broad applicability in healthcare environments while maintaining a cost-effective approach to patient care.

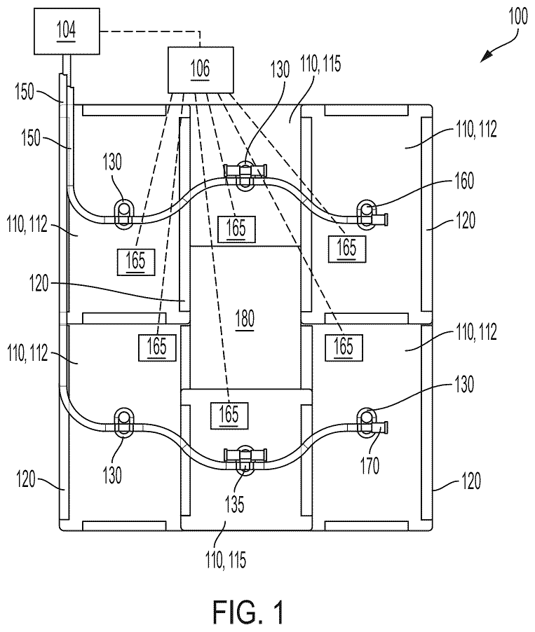

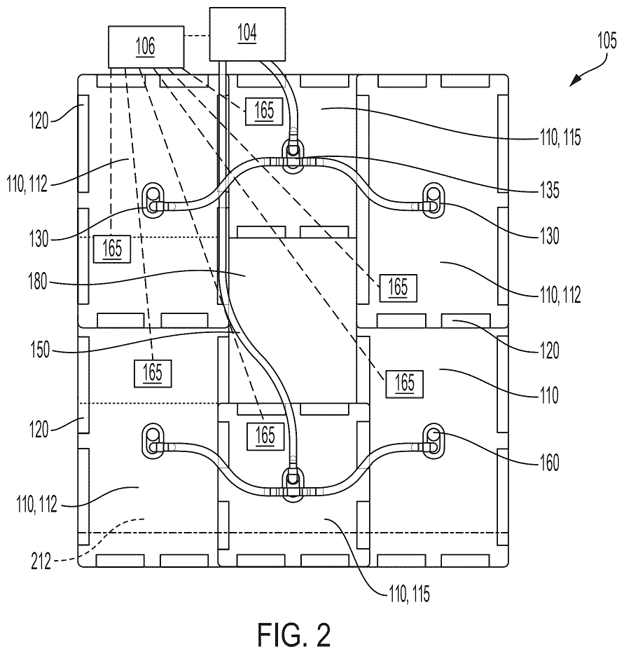

FIGS. 1-3A each illustrate a system for prevention of pressure-induced injuries according to various embodiments of the present disclosure. Each system includes a pad assembly 100 and a pressure source 104, such as a pump (e.g., a Wave Premium alternating pressure pump). The pad assembly 100 includes a plurality of pads 110, each including at least one fastener 120, a tube connector 135, and a plurality of tubes 150. As shown in FIGS. 1 and 2, the pads 110 can be fluidly connected to one another and to the pump 104 via the plurality of tubes 150. In the illustrated embodiment, the pad assembly 100 is positioned relative to a patient and the pads 110 are fluidly interconnected via the tubes 150, such that the pump 104 can be used to selectively inflate chambers 212 of the pads 110 with air or another gas, as will be discussed in greater detail below.

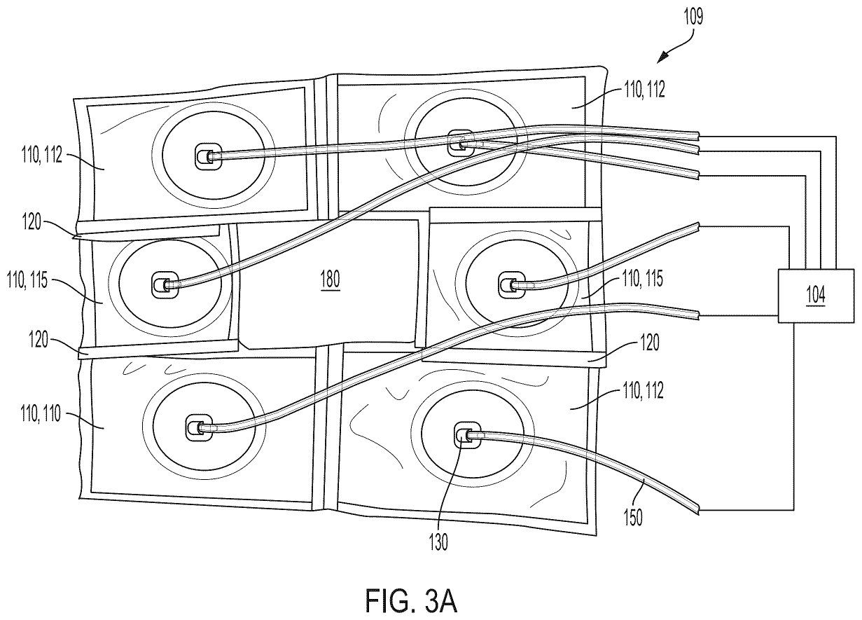

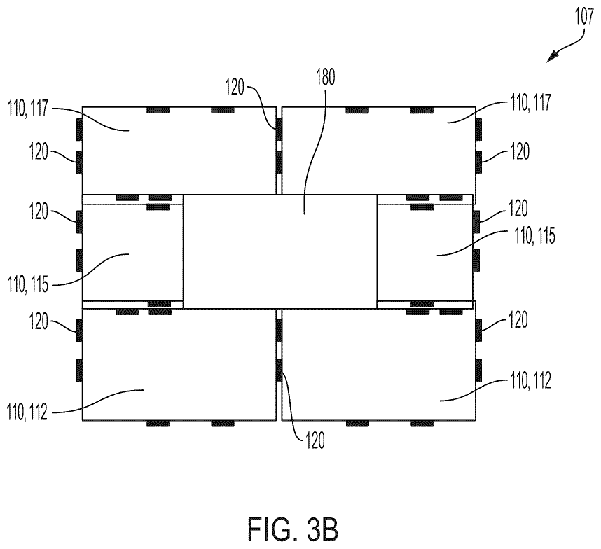

In the illustrated embodiments, the plurality of pads 110 have different sizes. As shown in FIGS. 1 and 2, the plurality of pads 110 include a plurality of first pads 112 that have a different size than a plurality of second pads 115. In the illustrated embodiment, the chambers 212 of the first pads 112 are larger than chambers 212 of the second pads 115. In these examples, the chambers 212 of the first pads 112 may measure 19.4 cm by 11.4 cm. In some examples, the chambers 212 of the second pads 115 may measure 12.4 cm by 11.4 cm. In other examples, such as FIGS. 3A and 3B, the plurality of pads 110 include a plurality of first pads 112, a plurality of second pads 115, and a plurality of third pads 117. In this example, the chambers 212 of the first pads 112 are larger than the chambers 212 of the second pads 115 and the chambers 212 of the third pads 117, and the chambers 212 of the third pads 117 are larger than the chambers 212 of the second pads 115. As illustrated, the chambers 212 of the third pads 117 have dimensions of 18 cm by 9.3 cm. The chambers 212 of the second pads 115 measure 9.3 cm by 11 cm. The chambers of the first pads 112 measure 18 cm by 11.4 cm. Thus, the pads may have any suitable measurement. For example, the pads may measure 8 cm to 20 cm by 8 cm to 12 cm.

In the embodiments of FIG. 1-3B, the pad assembly 100 has a first configuration. The first configuration includes a central opening 180 that is collectively formed by a combination the plurality of pads 110 (including the first pads 112, second pads 115, and/or third pads 117). In some examples, the central opening 180 is configured to be positioned beneath a patient such that the patient's sacral bony prominence aligns with the central opening 180. The central opening 180 may have dimensions of 9.3 cm by 14 cm or any suitable dimension. The pads 110 are removable and rearrangeable in any suitable configuration, as will be discussed below.

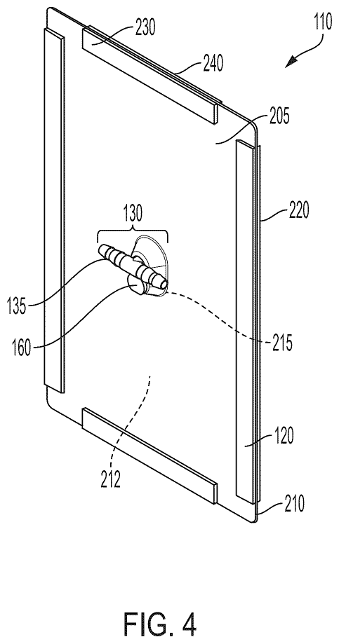

FIG. 4 illustrates a perspective view of one of the pads 110 of the pad assembly 100. Although the following discussion refers to one of the pads 110, it applies to all of the pads in the pad assembly 100 (including the first pads 112, the second pads 115, and third pads 117). The pad 110 includes one or more fasteners 120, the tube adapter 130, the tube connector 135, a plug 160, a first panel 205, and a second panel 210. In the illustrated embodiment, the pad 110 is rectangular and thus a perimeter thereof includes four sides. In other embodiments, the pad 110 may have other sizes and shapes. The first panel 205 and the second panel 210 are coupled together along their respective perimeters. Thus, collectively, the first panel 205 and the second panel 210 define the perimeter of the pad 110. In the illustrated embodiment, the first panel 205 and the second panel 210 may be coupled together via heat sealing or another suitable method. In some examples, the pads 110 are fabricated using a heat-sealable fabric. For example, the heat-sealable fabric may be a taffeta fabric, polyester microfiber, nylon, polyurethane film laminated fabrics, PVC-coated polyester, heat-sealable coated Oxford/packcloth, or reinforced pure thermoplastic films. In some embodiments, the heat-sealable fabric is TPU coated (e.g., TPU-coated nylon, polyester, ripstop). In some embodiments, a single piece of fabric is folded to create the first panel 205 and the second panel 210. Then, all four sides of the resulting panels 205, 210 may be heat sealed to couple the first panel 205 to the second panel 210. The chamber 212 is thus the space between the first panel 205 and the second panel 210. As discussed in greater detail below, the chamber 212 is selectively inflatable. The heat-sealed edge surrounding the perimeter of the pad 110 provides a suitable surface on both the first panel 205 and the second panel 210 for connection of the fastener 120. This is because panels 205, 210 in the area of the heat-sealed edge do not move or pucker due to the inflation of the chamber. In the illustrated embodiment, the first panel 205 includes an aperture 215 extending therethrough. In other embodiments, the second panel 210 may include the aperture 215 instead.

With respect to FIGS. 4-5B, and 8, the pads 110 of the embodiment of FIGS. 1-2 include a tube adapter 130 that is configured to couple to one or more tube connectors 135 or a plug 160. The tube adapter 130, the tube connectors 135, and the plug 160 may be formed from thermoplastic polyurethane (TPU), a TPU coated heat-sealable material, or another suitable heat-sealable material. In some embodiments, the tube adapter 130 may be formed from metal or another suitable material and directly welded to the pads 110.

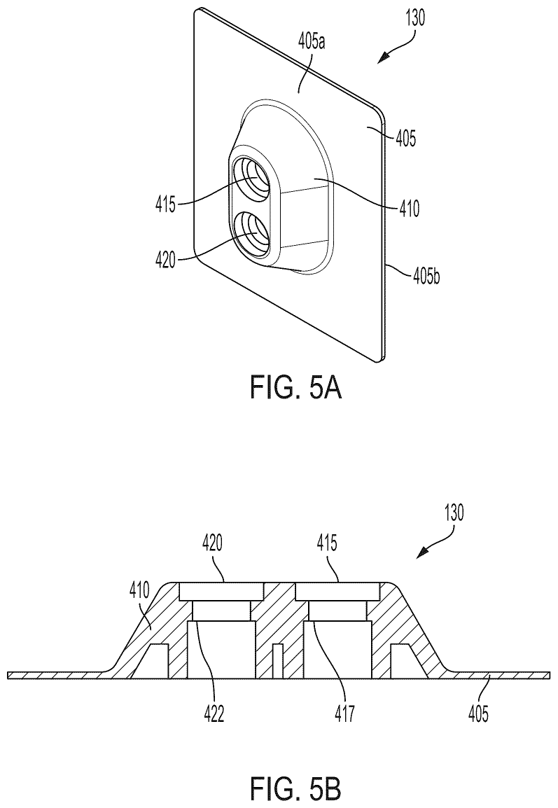

FIGS. 5A and 5B illustrate a tube adapter 130 in greater detail. The tube adapter 130 includes a base 405, a stem 410, a first channel 415, and a second channel 420. The base 405 is positioned within the chamber 212 and the stem 410 extends through the aperture 215 in the pad 110. The stem 410 thus projects from the first panel 205 of the pad 110. The base 405 includes a first face 405a and a second face 405b, opposite the first face 405a. The first face 405a is secured (e.g., via heat sealing, welding, or the like) to an inner surface of the first panel 205 of the pad 110. The stem 410 is configured to extend from the base 405. In some examples, the stem 410 defines the first channel 415 and the second channel 420. In some examples, the first channel 415 and the second channel 420 are defined by through-bores extending through the stem 410 and the base 405. As shown, each of the through-bores includes a lip 417, 422. The lips 417, 422 are configured to interact with and hold the tube connector 135 or plug 160 therein.

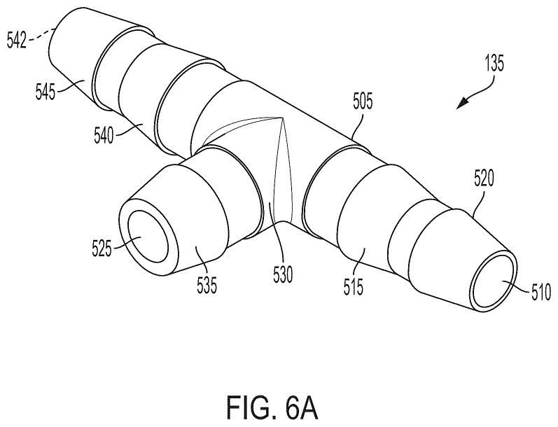

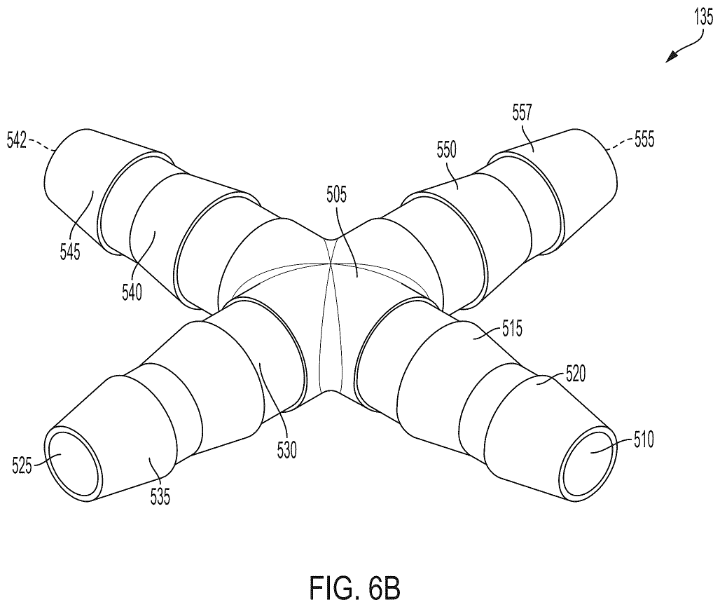

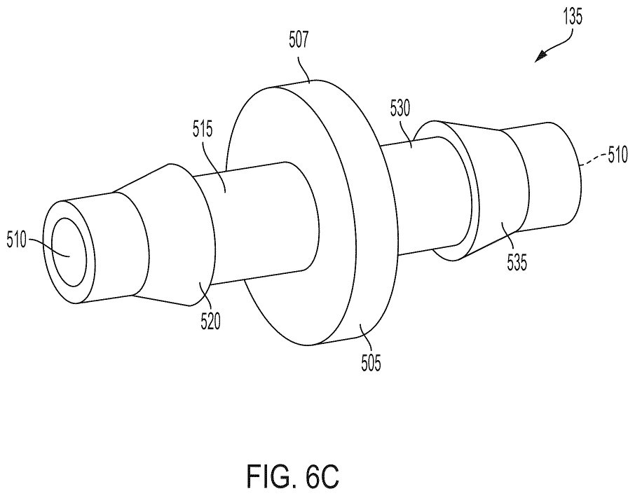

FIGS. 6A-6C illustrate exemplary tube connectors 135 for use with the tube adapter 130 of FIGS. 5A and 5B. With respect to FIG. 6A, the tube connector 135 includes a T-shaped body 505 that has a first arm 515 and a second arm 540 extending from a third arm 530. The first arm 515 includes a first channel 510 and a first collar 520, the second arm 540 includes a second channel 542 and a second collar 545, and the third arm 530 includes a third channel 525 and a third collar 535. The channels 510, 525, 542 are fluidly connected with one another. The collars 520, 535, 545 are configured to engage with the tube adapter 130 or the tubes 150. In the illustrated example, the third channel 525 is configured to couple with the first channel 415 and the second channel 420 of the tube adapter 130. That is, the third arm 530 is received within one of the through-bores of the tube adapter 130, such that the third collar 535 interacts with a lip 417, 422 to hold within the tube adapter 130. Also, tubes 150 may be in fluid communication with the first and third channels 510, 542. That is, the first arm 515 and the first collar 520 are configured to fluidly interact with one of the tubes 150 to hold the tube in place. Similarly, the third arm 540 and the third collar 545 are configured to fluidly interact with one of the tubes 150 to hold the tube in place. In the illustrated embodiment, the collars 520, 535, 545 are configured to snap or friction fit with the lips 417, 422 of the through-bores of the tube adapter 130 to couple the respective arm to the respective through-bore of the tube adapter 130. In other embodiments, the arms may instead have external threads that engage corresponding internal threads through-bores of the tube adapter 130. In still other embodiments, the arms may be configured to couple to the tube adapters 130 in other suitable ways.

While the tube connector 135 is T-shaped in the embodiment of FIG. 6A, in alternative embodiments, the tube connector 135 may be configured as a multi-channel connector including four channels (FIG. 6B), a single channel connector (FIG. 6C), right-angle connector, or other connector configurations capable of coupling one or more tubes of the plurality of tubes 150. The modularity of the pad assembly 100 is aided by the various tube connectors 135 that can be removably coupled to the tube adapter 130. This is because as the pads 110 are rearranged, so too can the orientation of the tube connectors 135. Accordingly, the tube connectors 135 of the pads 110 can receive the tubes 150 in any suitable configuration. The connectors 135 of FIGS. 6B and 6C have similar features to that of the T-shaped tube connector 135 of FIG. 6A and thus like structure will be identified with like reference numerals and only the differences discussed.

As illustrated in FIG. 6B, the multi-channel tube connector 135 includes a cross-shaped body 505 that has a first arm 515 and a second arm 530, a third arm 540, and a fourth arm 550. The first arm 515 includes a first channel 510 and a first collar 520, the second arm 530 includes a second channel 525 and a second collar 535, the third arm 540 includes a third channel 542 and a third collar 545, and the fourth arm 550 includes a fourth channel 555 and a fourth collar 557.

As illustrated in FIG. 6C, the single channel connector 135 is configured as a straight body 505. The straight body 505 may include a radially extending flange 507 that projects outward from an outer surface of the body 505. The single channel connecter 135 includes a first arm 515 and a second arm 530 extending on opposite sides of the flange 507. The body 505 defines a single channel 510 through the arms 515, 540 and includes collars 520, 535 at opposite ends thereof on the arms 515, 530.

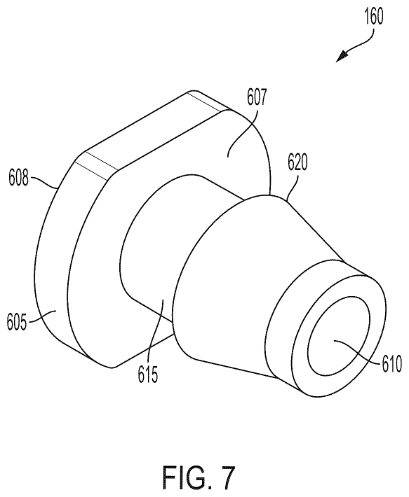

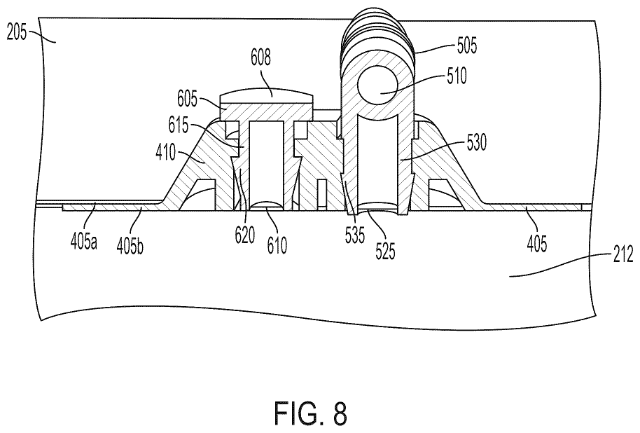

FIG. 7 illustrates a plug 160 for the tube adapter 130 of FIGS. 5A and 5B, according to some examples. The plug 160 includes a base 605 and an arm 615, which defines a channel 610. The base 605 includes a first face 607 and a second face 608, opposite the first face 607. The arm 615 includes a collar 620. The collar 620 is configured to interact with one of the lips 417, 422 of the tube adapter 130. The first face 607 of the base 605 is configured to interact with (e.g., engage) a face of the stem of the tube adapter 130, as shown in FIG. 8. The plug 160 is configured to create an airtight seal when disposed within one of the channels 415, 420 of the tube adapter 130. In some embodiments, the arm 615 and the collar 620 are replaced by threading that is configured to interact with a threading of the tube adapter 130.

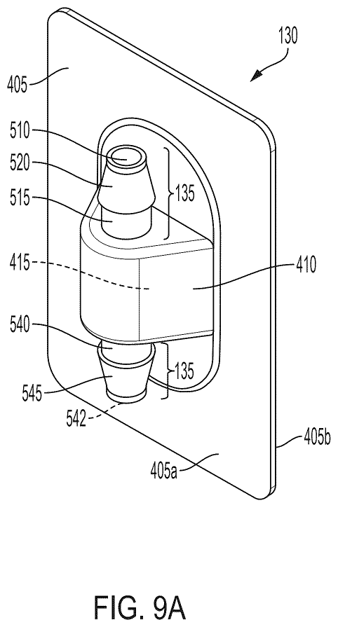

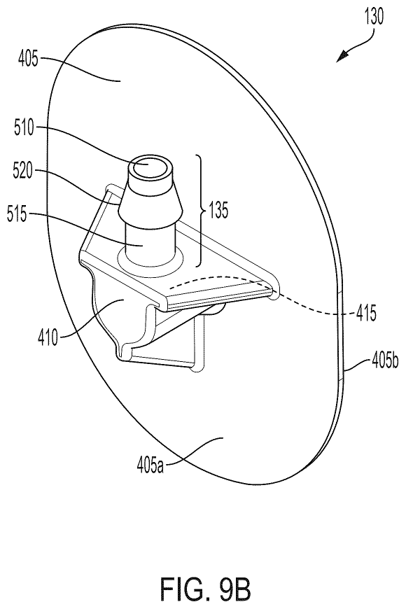

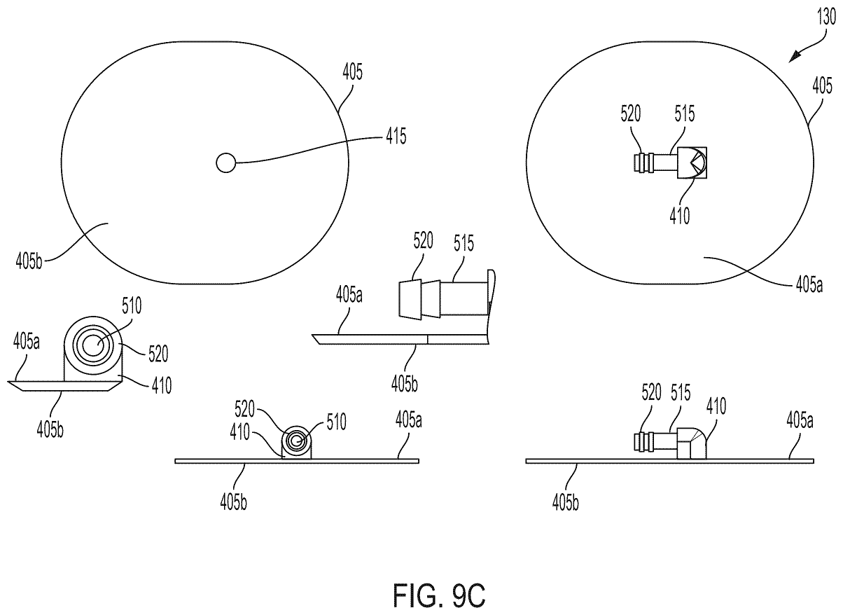

FIGS. 9A, 9B, and 9C illustrate tube adapters 130 for use with the pad assembly 100. As shown, the tube adapters 130 are integrally formed with tube connectors 135, but are otherwise generally similar to the tube adapter 130 and tube connectors 135 discussed above. Therefore, like structure will be identified with like reference numerals and only the differences discussed.

As shown, the tube adapter 130 includes a base 405, a stem 410, and a tube connectors 135. The stem 410 has a single channel 415 extending therethrough, although there may be more than one channel in other embodiments. In the embodiment of FIG. 9A, the tube connector 135, like the T-shaped connector above, includes two arms 515, 540. The two arms 515, 540 are integrally formed with and extend from the stem 410. In the embodiment of FIGS. 9B and 9C, the tube connector 135 includes a single arm 515 integrally formed with and extending from the stem 410 (FIGS. 9B and 9C). As shown, the arms 515, 540 may each include a channel 510, 542 extending therethrough and collars 520, 545. The channels 510, 542 are in fluid communication with the respective chamber 212 of the pad 110 via the channel 415 defined in the stem 410. At least one tube 150 is configured to fluidly couple to each of the tube connectors 135 via the collars 520, 545.

In the illustrated examples, the channel 415 of the stem 410 is coupled to the channels 510, 542 of the arms 515, 540 at a 90-degree angle. In some examples, the channel 415 of the stem 410 may be coupled to the channels 510, 542 of the arms at an angle between 90 degrees and 270 degrees. As shown, the tube adapter 130 may have a base 405 with any suitable shape, such as square, rectangle, oval, etc. In some examples, the tube adapter 130 includes an obround base with a predetermined length to width ratio. For example, the predetermined length to width ratio of the tube adapter 130 is 3.6. In some examples, the tube connector 135 is configured to attached with ¼ inch tubes 150. Moreover, in some examples, the stem 410 may be positioned at a center of the base or it may be offset from the center of the base. In some examples, the tube adapter 130 is disposed at a geometric center of the chamber 212 and of the pad 110, but in other embodiments, the tube adapter 130 may be positioned elsewhere relative to the chamber 212 and the pad 110.

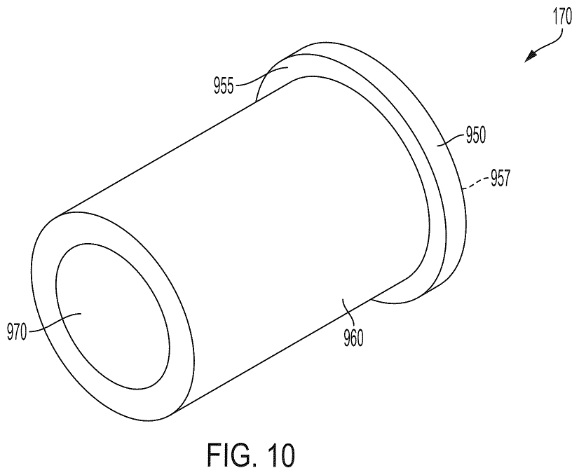

FIG. 10 illustrates a cap 170 for the tube connectors 135 discussed herein, according to some examples. The cap 170 includes a base 950 and a neck 960. The base 950 includes a first face 955 and a second face 957, opposite the first face 955. The neck 960 is configured as a hollow cylinder that couples to the base and defines a channel 970. In some examples, the channel 970 is configured to receive one of the collars of the respective tube connector 135. In some examples, the cap 170 is configured to create an airtight seal when disposed on the tube connector 135.

Returning to FIG. 4, the pad 110 includes at least one fastener 120. In the illustrated embodiment, the pad 110 includes a plurality of fasteners 120. In the embodiment of FIG. 4, each of the fasteners may be disposed on the perimeter pad 110. In the illustrated embodiment, each of the fasteners 120 is disposed along at least a portion of a side of the perimeter of pad 110. In the illustrated embodiment, each fastener extends along a majority of the respective side. Each of the fasteners 120 is configured to be removably coupled to a fastener 120 of an adjacent pad 110. In other embodiments, such as that of FIGS. 2 and 3A, there may be two or more fasteners 120 per side of the perimeter spanning all or a portion of the respective side.

In the illustrated embodiment, each of the fasteners 120 includes a first portion 230 and a second portion 240. The first portion 230 is coupled to the first panel 205 and the second portion 240 is coupled to the second panel 210. The fasteners 120 are hook and loop fasteners (e.g., Velcro® fasteners), in the illustrated embodiment. Therefore, the first portion 230 may include a plurality of hooks, while the second portion 240 may include a plurality of loops configured to couple with the plurality of hooks of the first portion 230. Thus, the first portion 230 and the second portion 240 of the fastener 120 of one pad may be coupled to the respective second portion 240 and first portion of the fastener 120 of an adjacent pad 110. In other embodiments, the fasteners 120, 220 may have other configurations. For example, the fasteners 120 may be adhesive fasteners, snaps, buttons, ties, clips, clamps, magnetic fasteners, or the like.

The tubes 150 are configured to couple to one or more of the tube connectors 135. In some examples, tubes 150 interconnect the chambers 212 of one or more pads 110. The plurality of tubes 150 may be arranged in various configurations, including one-to-one connections between corresponding pads 110, branching configurations in which a single tube is coupled to multiple pads 110, or the like. As shown, in embodiments of FIGS. 1 and 2, a plurality of first tubes 150 is configured to fluidly connect to a first subset of pads 110 (and the chambers 212 thereof) with the pump 104 and a plurality of second tubes 150 is configured to fluidly connect a second subset of pads 110 (and the chambers 212 thereof) to the pump 104. Thus, in the embodiments of FIGS. 1 and 2, each of the first and second subset of pads is coupled to the pump 104 because the pads are daisy chained together via the tubes 150. In other embodiments, such as that of FIG. 3A, each of the pads 110 (and the chambers 212 thereof) may be individually coupled to the pump 104 via a tube 150.

In some examples, each pad 110 may include a sensor 165 (e.g., a pressure sensor) positioned within the chamber 212 of each pad 110. In such case, the system may include a controller 106 that is in communication with the pressure sensor 165 of each chamber 212 and the pump 104. In some examples, the controller 106 is configured to adjust, via the pump 104, a pressure within the chamber 212 of each pad 110. In some examples, inflation, via the pump 104 of the chambers 212 occurs by column or subset with all three chambers 212 of one subset inflating simultaneously (such that of FIGS. 1 and 2). After reaching peak inflation, the inflated subset deflates while the other subset inflates. In some examples, such as FIG. 3A, inflation of the chambers 212 occurs individually with all chambers inflating simultaneously or asynchronously.

The fasteners 120 disposed on the sides of the pads 110 allow for the pad assemblies 100 disclosed herein to be rearranged to accommodate a patient's needs. A standard configuration may be configured to offload pressure from the sacral bony prominence. For example, the first pads 110 and the second pads 115 are removably coupled such that the central opening 180 is in the center of the pad assembly 100. The pad assembly 100 is designed for positioning beneath a patient such that the patient's sacral bony prominence aligns with the central opening 180 of the system 1200.

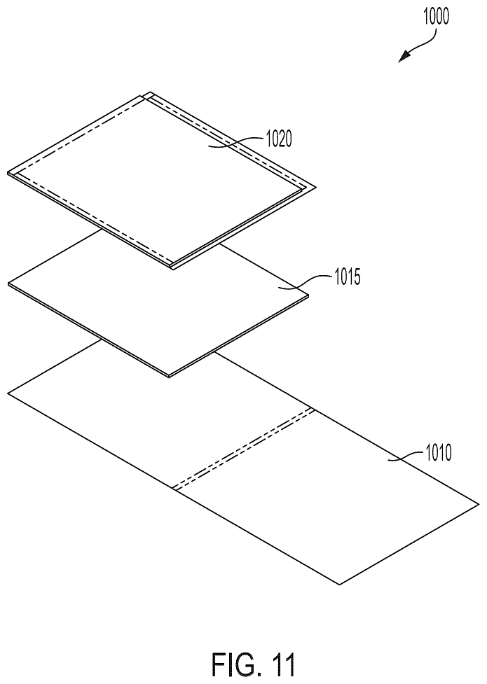

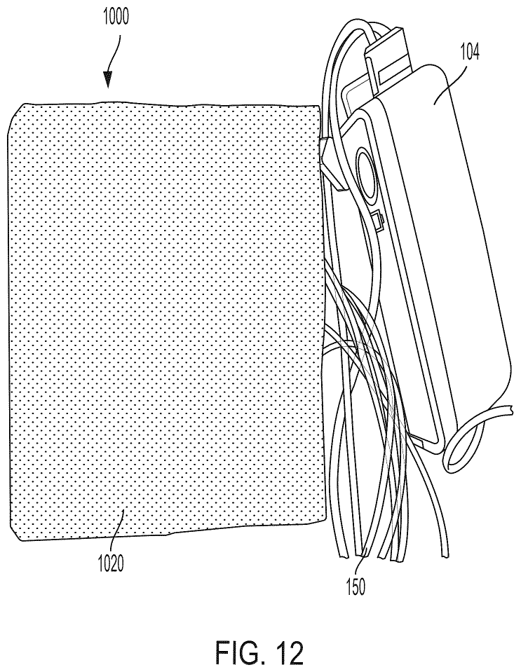

As shown in FIGS. 11 and 12, the pad assembly 100 is positioned within a removable cover 1000 and the tubes 150 extend through one side (an unsealed side) of the cover 1000 to the pump 104, which is located external to the cover 1000. In some examples, the cover 1000 measures 42 cm by 33.5 cm. With reference to FIG. 11, the cover 1000 includes three fabric layers 1010, 1015, 1020 to prioritize hygiene and moisture management. The first or inner layer 1010 of the cover 1000, which remains in contact with the pad assembly 100 during use, provides a first fluid barrier and is made from a first material or fabric. In the illustrated embodiment, the first material is hydrophobic or otherwise non-absorbent to prevent absorption of fluid and protect the pad assembly 100 from moisture exposure. The first material may be a polypropylene fabric, polyurethane laminate (PUL), silicone, or TPU coated polyester or polypropylene, polyurethane (PU)-coated woven polyester, coated nylon, polytetrafluoroethylene (PTFE)-based fabrics, or ultra-high-molecular-weight polyethylene (UHMWPE). The second or middle layer 1015 of the cover 1000, which is positioned between the first layer 1010 and the third layer 1020, provides a second fluid barrier and cushioning, and is made from a second material, different from the first material. The second material is a moderately hydrophobic or non-absorbent fabric, such as neoprene, a 3D spacer fabric, EVA foam, silicone gel layer or open cell polyurethane foam, scuba fabric, space mesh, TPU foam laminated fabric, natural rubber, EVA foam laminated fabric, silicone rubber sheets. The third or outer layer 1020 of the cover 1000, which is configured to contact with the patient, provides comfort and moisture management and is formed from a third material, which is different from the first material and the second material. The third material is preferably absorbent or superabsorbent. The third material may be a multi-layer fabric including a wicking layer (e.g., a hydrophobic fabric such as polypropylene nonwoven fabric), a storage layer (e.g., including cellulose and a superabsorbent polymer (SAP)), and a semi-water permeable layer (e.g., a waterproof breathable fabric). In some embodiments, the third material may also include moisture-wicking polyester, bamboo viscose blends, terry knit or antimicrobial treated fabrics (e.g., silver ions, etc.). This configuration provides comfort and efficient moisture wicking absorption to enhance patient care.

In one exemplary embodiment, as shown in FIG. 11, the second layer 1015 may be positioned on the first layer 1010 and the third layer 1020 may be positioned on the second layer 1015 before the first layer 1010 is folded in half over the second and third layers 1015, 1020. Once folded, three of the edges may be sewn or otherwise sealed, while one remains unsewn or unsealed. Then, the cover 1000 is inverted such that the sealed edges (e.g., seams) are hidden, and the first layer is on the inside of the cover 1000. The unsealed edge enables the tubes 150 to extend therethrough Also, the unsealed side of the cover 1000 allows the cover 1000 to be easily slipped over and removed from the pad assembly 100.

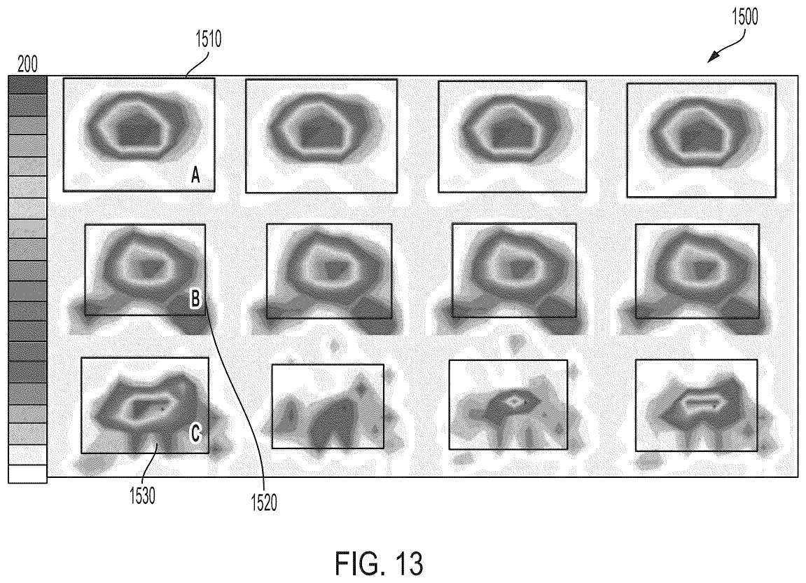

FIG. 13 illustrates a plurality of pressure maps 1500 for the pad assembly 100 of FIG. 3B, according to some examples. As shown in FIG. 13, the pressures range from 0 millimeters of mercury (“mmHg”) to 200 mmHg. In some examples, a pressure of 0 mmHg is illustrated by a white color. In some examples, a pressure of 200 mmHg is illustrated by a red color. In some embodiments, a rainbow gradient of color illustrates a decrease of pressure (e.g., orange is less pressure than red, yellow is less pressure than orange, etc.). As illustrated in FIG. 13, three separate tests were run: Test A 1510, Test B 1520, and Test C 1530. The pressure maps for Test A 1510 include four pressure maps arranged in a row, with the leftmost pressure map labeled “A” and the three pressure maps to the right corresponding to the same Test A 1510. The pressure maps for Test B 1520 include four pressure maps arranged in a row, with the leftmost pressure map labeled “B” and the three pressure maps to the right corresponding to the same Test B 1520. The pressure maps for Test C 1530 include four pressure maps arranged in a row, with the leftmost pressure map labeled “C” and the three pressure maps to the right corresponding to the same Test C 1530.

Test A 1510, as shown in FIG. 13, represents a pressure test of a patient where no support was used under a patient's sacral bony prominence. Test B 1520, as shown in FIG. 13, represents a pressure test of a patient where a static support cushion was used under a patient's sacral bony prominence. As illustrated by Test A 1510 and Test B 1520, the pressure remained generally constant within the center of the measured area. The pressure measured in Test A 1510 had relatively larger areas of high pressure than the areas of high pressure measured in Test B 1520. Test C 1530, as shown in FIG. 13, represents a pressure test of a patient where the pad assemblies 100 of FIG. 3A of the present disclosure was used under a patient's sacral bony prominence. The pressure maps of Test C 1530 illustrated a dynamic pressure adjustment where points of high pressure were relieved and/or a pressure was distributed. As shown, peak pressure decreased from 193 mmHg to 59 mmHg due to the use of the system of FIG. 3A. Thus, there is a visible and quantifiable decrease and shift in pressure with the use of the pad assemblies 100 disclosed herein, as compared to no cushion or a static cushion.

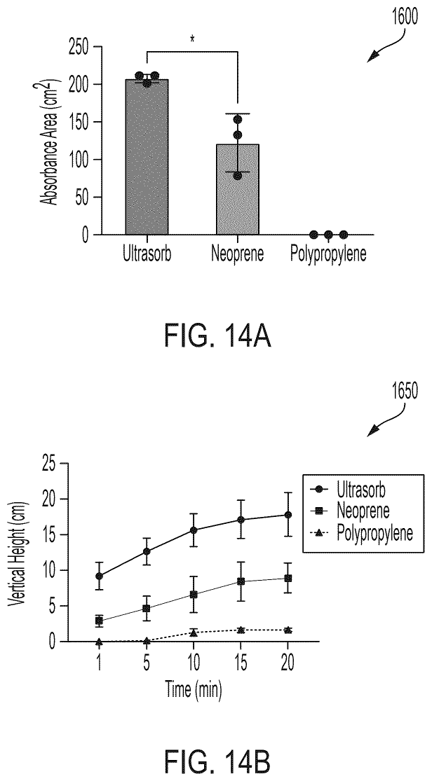

FIG. 14A illustrates a graph 1600 of absorbance versus material type for a horizontal wicking test for the cover 1000 of FIGS. 11-12, according to some examples. The graph 1600 illustrates a bar graph with three separate bars that illustrate an absorbance area for three separate materials. Each material was subjected to 5 milliliters (“mL”) of water and the absorbance per squared centimeter area was observed. A first, leftmost bar, represents absorbance for an Ultrasorbs sample. A second, middle bar, represents absorbance for a neoprene material. A third, rightmost bar, represents absorbance for a polypropylene material. As shown in FIG. 14A, the Ultrasorbs sample had the highest absorbance area of approximately 200 square centimeters (“cm²”). The neoprene material had a second highest absorbance area of approximately 125 cm². The polypropylene sample had a smallest absorbance area of 0 cm².

FIG. 14B illustrates a graph 1650 of vertical height versus time for different materials in a vertical wicking test for the cover 1000 of FIGS. 11-12, according to some examples. The graph 1650 illustrates a scatter plot with three separate data sets that illustrate vertical absorption over time for three separate materials. Each material was placed in a container with 100 mL of water and left in the container for 20 minutes. As illustrated in the embodiment, the vertical absorbance of the Ultrasorbs sample was measured to be approximately 9 cm after a first minute of the test and approximately 16 cm after the twentieth minute of the test. The vertical absorbance of neoprene sample was measured to be approximately 3 cm after the first minute of the test and approximately 8 cm after the twentieth minute of the test. The vertical absorbance of polypropylene sample was measured to be approximately 0 cm after the first minute of the test and approximately 2 cm after the twentieth minute of the test.

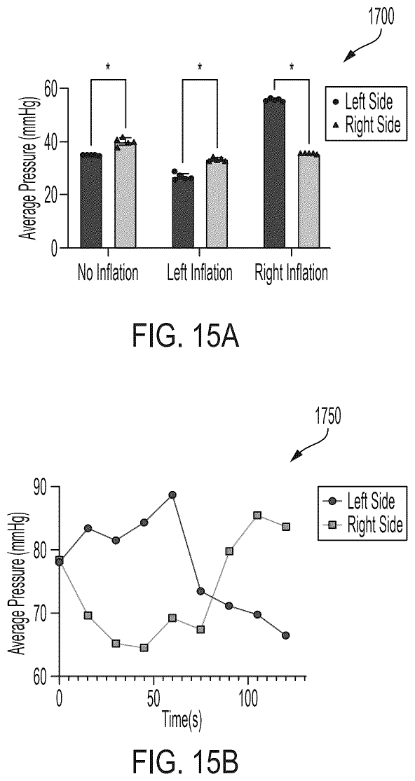

FIG. 15A illustrates a graph 1700 of pressure mapping quantification for the pad assemblies 100 of FIGS. 1-3B, according to some examples. The graph 1700 illustrates an average pressure measurement for a left side and a right side of a patient under different inflation conditions. The inflation conditions included no inflation, left-side inflation, and right-side inflation. The average pressure on each side varied depending on which portion of the system was inflated. A left-side measurements and a right-side measurements are illustrated separately for each condition in FIG. 15A. The graph 1700 demonstrated that selectively inflating one side of the system alters the pressure distribution between the left and right sides relative to the no-inflation condition. This comparison illustrated how different inflation configurations may be used to redistribute pressure across opposing sides of the patient in order to decrease pressure on any certain point on the patient's body to prevent tissue ischemia and pressure sore progression.

FIG. 15B illustrates a graph 1750 of pressure mapping quantification for the pad assemblies 100 of FIGS. 1-3B, according to some examples. The graph 1750 illustrates average pressure measurements over time for left and right sides of a patient. The average pressure on each side varied as a function of time, with the left-side pressure and the right-side pressure plotted separately across a series of time intervals. The graph 1750 demonstrated that pressure on the left side and the right side may change independently over time, which resulted in differing pressure profiles between the two sides during the measurement period. The temporal comparison illustrated how pressure distribution across opposing sides of the subject may vary during operation of the pad assemblies 100.

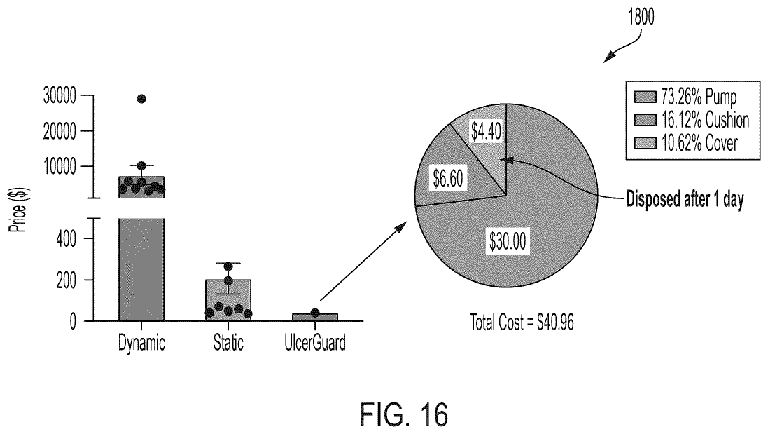

FIG. 16 illustrates a cost analysis 1800 for the pad assemblies 100 of FIGS. 1-3B, according to some examples. As shown, the total cost of the pad assemblies 100 was broken down among constituent components, including a pump, a cushion, and a cover, with the relative cost contribution of each component illustrated. The cost analysis 1800 further indicated that certain components, such as the cover, may be disposed of after a limited period of use, for example after one day, while other components may be reusable. The cost analysis 1800 demonstrated that the disclosed system achieves a lower overall cost relative to dynamic and static systems currently available on the market, while maintaining functionality suitable for ulcer prevention.

Although the disclosure has been described in detail with reference to certain embodiments and examples, variations and modifications exist within the scope and spirit of one or more independent aspects of the disclosure as described.

Various features and advantages of the disclosure are set forth in the following claims.

What is claimed is:

1. A pad assembly for preventing pressure-induced injuries, the pad assembly comprising:
a plurality of pads, each of the plurality of pads including a chamber and a fastener;
a tube connector in fluid communication with the chamber of each of the plurality of pads;
a plurality of tubes, each of the plurality of tubes configured to couple to the tube connector of at least one of the plurality of pads;
wherein the fastener of each of the plurality of pads is configured to removably couple to the fastener of at least one adjacent pad of the plurality of pads,
wherein the plurality of pads is couplable to one or more adjacent pads of the plurality of pads in a first configuration and the plurality of pads is couplable to one or more of adjacent pads of the plurality of pads in a second configuration different from the first configuration; and
wherein the chamber of each of the plurality of pads is configured to receive air through the tube connector corresponding thereto and one of the plurality of tubes, such that the chamber of each of the plurality of pads is selectively inflatable.

2. The pad assembly of claim 1, wherein the plurality of pads includes a first subset of pads and a second subset of pads, and wherein the second subset of pads is larger than the first subset of pads.

3. The pad assembly of claim 1, wherein each of the plurality of pads includes a perimeter, a first panel, and a second panel that is coupled with the first panel along the perimeter, and wherein the chamber is positioned between the first panel and the second panel.

4. The pad assembly of claim 3, wherein the fastener includes a first portion coupled to the first panel and a second portion coupled to the second panel.

5. The pad assembly of claim 3, wherein for each pad of the plurality of pads, the perimeter is defined by a plurality of sides and the fastener is one of a plurality of fasteners, and wherein one of the plurality of fasteners is coupled along at least a portion of each side of the plurality of sides.

6. The pad assembly of claim 3, wherein the tube connector is coupled to an adapter at least partially positioned within chamber, and wherein the tube connector is in fluid communication with the chamber through the adapter.

7. The pad assembly of claim 6, wherein for each pad of the plurality of pads, the adapter includes a base and a stem extending from the base, wherein the base is positioned within the chamber and the stem extends through an aperture in one of the first panel and the second panel, and wherein the stem defines a channel configured to communicate with the one of the plurality of tubes via the tube connector to route the air into the chamber.

8. The pad assembly of claim 1, wherein in at least one of the first configuration and the second configuration, the plurality of pads collectively defines a central opening.

9. A pad assembly for preventing pressure-induced injuries, the pad assembly comprising:
a plurality of pads, each of the plurality of pads configured to couple to one or more adjacent pads and including a chamber;
a tube connector in fluid communication with the chamber of each of the plurality of pads;
a plurality of tubes, each of the plurality of tubes configured to couple to the tube connector of at least one of the plurality of pads;
wherein the chamber of each of the plurality of pads is configured to receive air through the tube connector corresponding thereto and one of the plurality of tubes, such that the chamber of each of the plurality of pads is selectively inflatable.

10. The pad assembly of claim 9, wherein the plurality of pads includes a first subset of pads and a second subset of pads, and wherein the second subset of pads is larger than the first subset of pads.

11. The pad assembly of claim 9, wherein each of the plurality of pads includes a perimeter, a first panel, and a second panel that is coupled with the first panel along the perimeter, and wherein the chamber is positioned between the first panel and the second panel.

12. The pad assembly of claim 11, wherein the tube connector is coupled to an adapter at least partially positioned within chamber, and wherein the tube connector is in fluid communication with the chamber through the adapter.

13. The pad assembly of claim 12, wherein for each pad of the plurality of pads, the adapter includes a base and a stem extending from the base, wherein the base is positioned within the chamber and the stem extends through an aperture in one of the first panel and the second panel, and wherein the stem defines a channel configured to communicate with the one of the plurality of tubes via the tube connector to route the air into the chamber.

14. The pad assembly of claim 13, wherein the stem of the adapter comprises a through-bore that at least partially defines the channel and that is configured to removably receive the tube connector, such that the tube connector is in fluid communication with the channel.

15. The pad assembly of claim 9, wherein
the plurality of pads includes a first subset of pads and a second subset of pads;
the plurality of tubes includes a first subset of tubes and a second subset of tubes;
the first subset of tubes is configured to fluidly interconnect the tube connector of each pad of the first subset of pads;
the second subset of tubes is configured to fluidly interconnect the tube connector of each pad of the second subset of pads.

16. The pad assembly of claim 9, wherein the plurality of pads collectively define a central opening.

17. The pad assembly of claim 9, further comprising a cover configured to at least partially enclose the plurality of pads.

18. A system for preventing pressure-induced injuries, the system comprising:
a pump; and
a pad assembly including
a plurality of pads, each of the plurality of pads configured to coupled to one or more adjacent pads and including a chamber;
a tube connector in fluid communication with the chamber of each of the plurality of pads;
a plurality of tubes, each of the plurality of tubes configured to couple between the pump and the tube connector of at least one of the plurality of pads;
wherein the chamber of each of the plurality of pads is configured to receive air from the pump through the tube connector corresponding thereto and one of the plurality of tubes, such that the chamber of each of the plurality of pads is selectively inflatable.

19. The system of claim 18, wherein
the plurality of pads includes a first subset of pads and a second subset of pads;
the plurality of tubes includes a first subset of tubes and a second subset of tubes;
the first subset of tubes is configured to fluidly interconnect the tube connector of each pad of the first subset of pads with the pump;
the second subset of tubes is configured to fluidly interconnect the tube connector of each pad of the second subset of pads with the pump; and
the pump iteratively inflates the first subset of pads and the second subset of pads.

20. The system of claim 18, further comprising a cover configured to at least partially enclose the pad assembly.
